(19) United States
(12) Patent Application Publication
(10) Pub. No.: US 2025/0139166 A1
(43) Pub. Date: May 1, 2025

(54) DATABASE MANAGEMENT SYSTEM BASED ON PREFRACTAL GRAPHS

(71) Applicant: Dmitri Pescianschi, Einbeck (DE)

(72) Inventor: Dmitri Pescianschi, Einbeck (DE)

(21) Appl. No.: 18/928,381

(22) Filed: Oct. 28, 2024

Related U.S. Application Data
(60) Provisional application No. 63/593,835, filed on Oct. 27, 2023.

(51) Int. Cl. G06F 16/901; G06F 16/906

(52) U.S. Cl. CPC G06F 16/9024; G06F 16/906

(57) ABSTRACT

A database management system that provides significant performance improvements in information retrieval and processing. The database management system enables users to retrieve and process information contained within a database of data and metadata and includes a prefractal graph structure. The prefractal graph structure has a plurality of nodes connected by arbitrary directed or undirected edges with each other. Each node further includes a separate graph structure and is labeled with one or more labels that define to which category the node belongs. The edges define a relationship between the nodes, and each edge is labeled with one or more labels that define which category the relationship belongs to. Further, each node and each edge includes an attribute of any desired type. The database management system is highly versatile and allows for efficient data handling in tasks specific to different types of databases.

### CROSS-REFERENCE TO RELATED APPLICATIONS

This application claims all rights of priority to U.S. Provisional Patent Application No. 63/593,835, filed on Oct. 27, 2023 (pending).

### FIELD OF INVENTION

The invention generally relates to database management systems. More specifically this invention relates to a method and apparatus for implementing information processing and data transformation within a database system based on prefractal graphs.

### BACKGROUND OF THE INVENTION

Over the past years the use of databases for storing, retrieving and transformation of data has emerged as an important tool in a wide variety of commercial applications. Databases of different types are used to work with data. The most common today are Relational—SQL databases and a number of NoSQL databases, such as Key-Value databases, Graph databases, Document-oriented databases (Hierarchical), Time Series databases, Object databases. This variety of database types is due to their incomplete universality. Each type has advantages in some classes of tasks and disadvantages in others.

Relational databases are databases based on the relational data model. All data is stored in tables. All records belonging to the same table have the same structure, i.e., a set of the same fields. Accordingly, to add a field to a record a user must add this field to all records in the table. Relationships between tables are virtual in nature, as they are created using key fields. To select related records, a search for records with identical keys is required. This format of storing records and links makes “many to many” links between tables impossible. Formation of such relations requires introduction of artificial intermediate tables. The virtual mechanism of storing links in keys leads to the increased complexity of links, e.g., the second, third, fourth and more levels, resulting in a non-linear increase of time spent on information retrieval. This makes relational databases not quite universal because, for certain types of data, a relational search becomes unacceptably slow.

Further, this structure of storing and searching for information and relationships makes relational databases very poorly suited for storing structures such as hierarchies, graphs, and time series. Storing records in tables causes search times to increase as a function of the number of records, even for indexed data. In the case of non-indexed data, the search time grows linearly depending on the number of records in the table. Finally, this method of storing information makes data unintuitive, difficult to understand, develop and modify.

Key-value databases are databases designed to store, retrieve, and manage associative arrays, a data structure better known today as a dictionary or hash table. Dictionaries contain a collection of objects or records, which in turn contain many different fields, each containing data. These records are stored and retrieved using a key that uniquely identifies the record and is used to quickly search the data in the database. Such databases provide exceptionally fast key-based data retrieval, independent of either the number of records or the indexing of that data. Key-value systems treat the data as a single opaque collection that can have different fields for each record. This system provides considerable flexibility and more closely follows modern concepts such as object-oriented programming. Because optional values are not represented by placeholders or input parameters, as in most relational databases, key-value databases often use much less memory to store the same database, which can result in significant performance gains for certain workloads. However, the performance of dictionary lookup comes at the price of lack of versatility. Data integrity is not guaranteed in such databases. Any data structures other than dictionaries are extremely poorly supported. In addition, search is supported only by the key, i.e. search by value is impossible or extremely inefficiently realized. There is no metadata model.

Graph databases are databases in which the network model realization is in the form of a graph with properties residing in nodes and edges (relationships), which are the main elements of the model. Specialized graph computing engines are used for analytical work with large volumes of data in graphs. For tasks with natural graph structure of data, graph databases can significantly exceed relational databases in performance, as well as have advantages in the clarity of presentation and ease of making changes to the database. Graph databases support “many to many” relationships and do not require creation of additional artificial structures for this purpose, as required, for example, in relational databases. These graph databases, however, are also not universal, as for certain classes of tasks graph databases are ineffective. For example, for the tasks of storing hierarchical data graph databases are poorly adapted. The only way to form hierarchies is to create specialized links describing hierarchical dependencies. For large data, this leads to a significant consumption of resources and a sharp decrease in performance. One of the most serious disadvantages of such databases is the lack of a metadata model—the model is the data itself, but this makes it extremely difficult to analyze metadata.

Document-oriented databases are databases specially designed for storing hierarchical data structures (documents) and are usually implemented using the NoSQL approach. Document-oriented databases are based on document stores that have a tree (or sometimes forest) structure. The tree structure starts with the root node and may contain several internal and leaf nodes. Leaf nodes contain data that are added to indexes when adding a document, which allows for finding the location (path) of the searched data even with a rather complex structure. Search API allows finding documents and parts of documents by request. Unlike key-value type storages, a selection on a query to a document store can contain parts of a large number of documents without fully loading these documents into RAM.

Similarly, to other NoSQL databases, document-oriented databases are not universal. They are used in content management systems, publishing, document retrieval, and the like, providing high performance for searching hierarchical data. However, such databases are incapable of ensuring data integrity and are inefficient in handling structures other than hierarchical ones. Data and metadata models are lacking.

Time Series databases are software systems that are optimized for storing and serving time series through associated pairs of time(s) and value(s). In some fields, time series may be called profiles, curves, traces or trends. Such databases are extremely specialized NoSQL databases, effectively solving only time series tasks. There are no data models or metadata.

Object databases are database management systems in which information is represented in the form of objects as used in object-oriented programming. Object databases are different from relational databases which are table-oriented. Object databases are usually recommended in systems where high-performance processing of complex data is required. An object database stores complex data and relationships between data directly, without mapping to relational rows and columns, and this makes them suitable for applications dealing with very complex data. Objects have a many-to-many relationship and are accessed by the use of pointers. Pointers are linked to objects to establish relationships. Objects in an object database can store any number of simple types and other objects. This allows to form not only graph structures, but also hierarchical structures. Object database is more suitable for processing multifaceted and complexly interconnected data and, depending on the complexity of data, can surpass relational databases in performance by tens, and even thousands, of times. However, object databases are inferior to relational databases in flexibility because the queries that can be executed over data in an object database depend more on the design of the system. The design of classes in an object database can impose its own limitations on the methods for working with data. There is no way to bind classes that have no relationship in the UML model with a query. In addition, changing the data structure is always associated with rebuilding applications that use such databases, which makes object databases inflexible. The use of object databases is largely limited by the fact that there is no common data model.

Advantages and disadvantages of various database systems are summarized in the table of FIG. 1. Accordingly, there is a need in the art for a more universal, flexible and efficient database implementing and management system.

### SUMMARY

In its most general aspect, the invention is a database management system that provides significant performance improvements in information retrieval and processing. The database management system enables users to retrieve and process information contained within a database of data and metadata and includes a prefractal graph structure. The prefractal graph structure has a plurality of nodes connected by arbitrary directed or undirected edges with each other. Each node further includes a separate graph structure and is labeled with one or more labels that define to which category the node belongs. The edges define a relationship between the nodes, and each edge is labeled with one or more labels that define which category the relationship belongs to. Further, each node and each edge includes an attribute of any desired type. The database management system is highly versatile and allows for efficient data handling in tasks specific to different types of databases.

### BRIEF DESCRIPTION OF THE DRAWINGS

The invention is illustrated by way of examples which are not a limitation, and the figures of the accompanying drawings in which references denote corresponding parts, and in which:

FIG. 1 shows a table summarizing advantages and disadvantages of various existing database systems;

FIG. 2 shows a representative embodiment of a three-level hierarchical database structure;

FIG. 3 shows a matrix representation of a graph;

FIG. 4 shows a matrix representation of the hierarchy; and

FIG. 5 shows a table summarizing advantages of the present system.

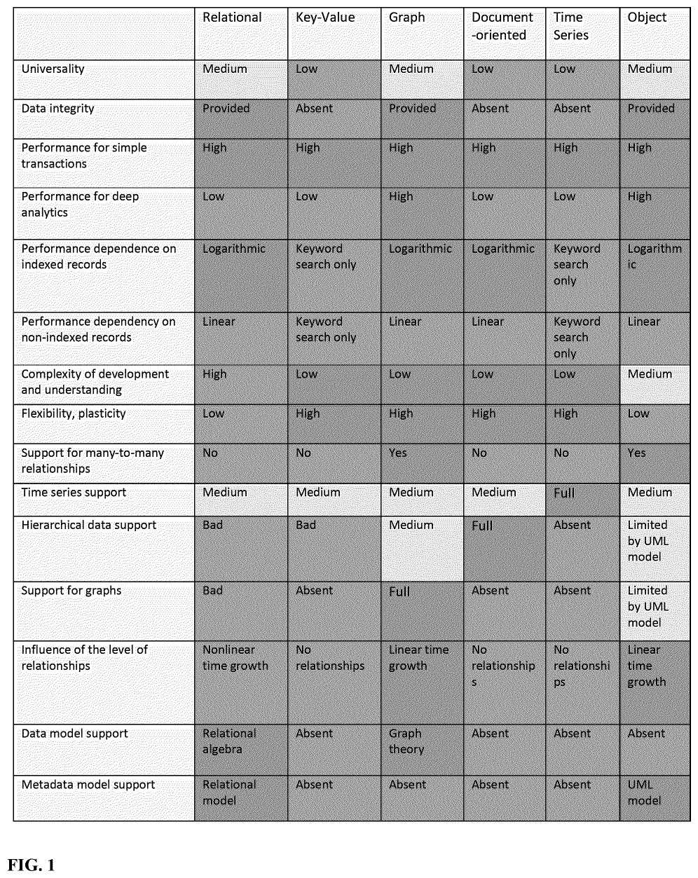

### DESCRIPTION OF THE INVENTION

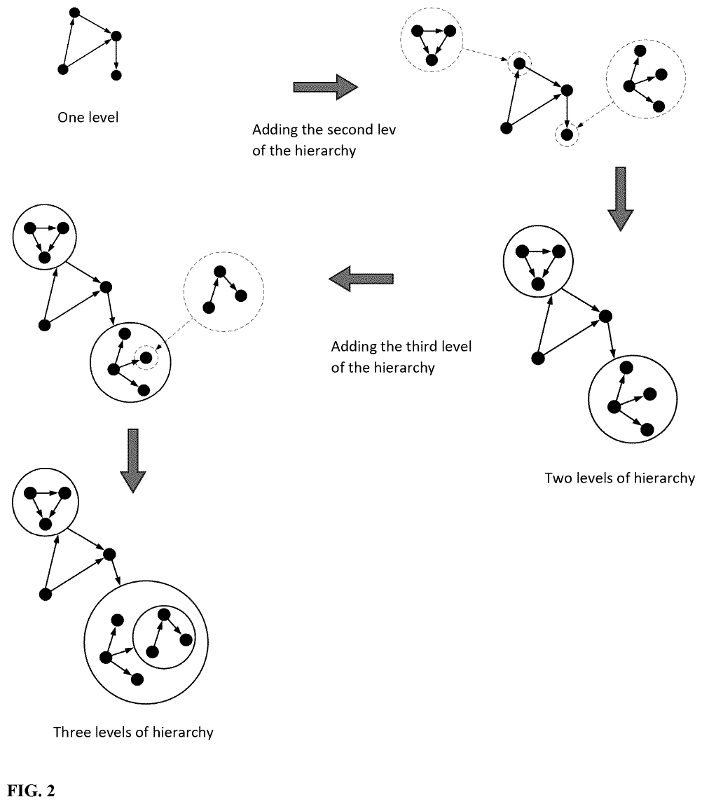

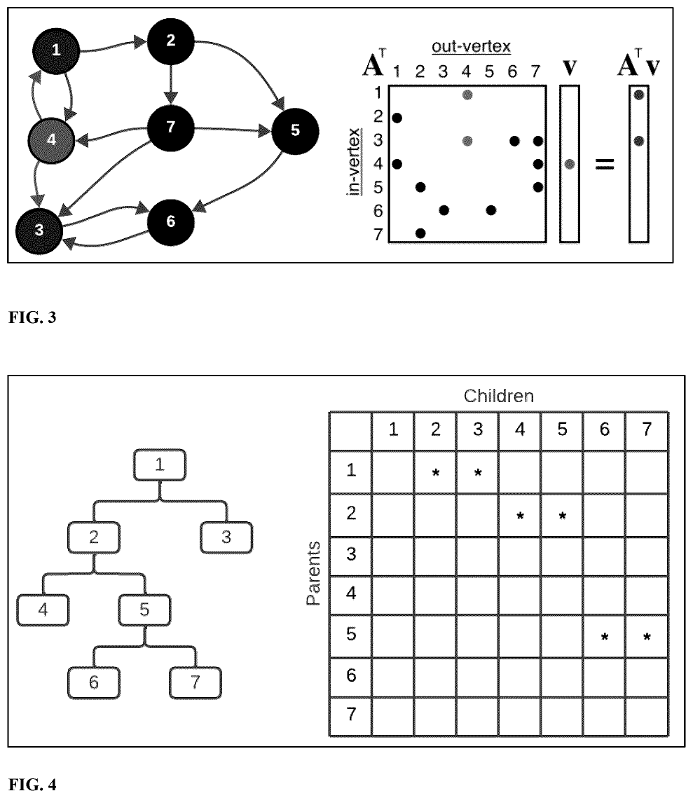

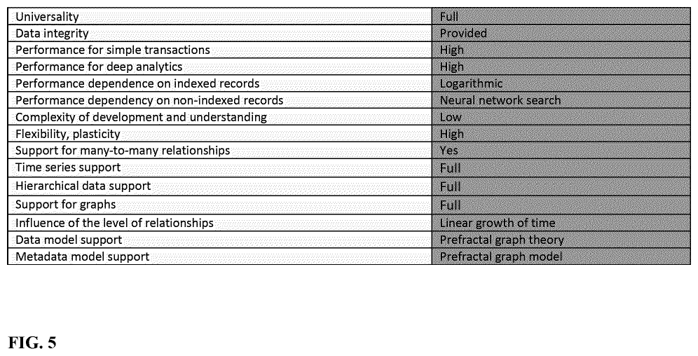

The proposed invention uses a mathematical construct of prefractal graphs as a data model. The database management system built on this basis allows to use simultaneously one apparatus for both graphs and hierarchies of any level of nesting. A prefractal graph is a structure consisting of nodes connected by arbitrary directed or undirected relationships with other nodes. Moreover, the nodes are not indivisible objects, but can themselves represent a graph structure consisting of similar nodes. Thus, a prefractal graph is a graph with a hierarchical structure of nodes of any nesting level. A representative embodiment of a three-level hierarchical database structure is shown in FIG. 2.

Each node is labeled with one or more labels that define to which category the node belongs. In relational databases, the table name can serve as an analogy. However, a table can have only one name, while a node can have one or more labels.

Each node can contain an arbitrary number of attributes of different types. Nodes with the same label are not required to contain an identical set of attributes.

Each edge (relationship) is labeled with one or more labels that define which category the relationship belongs to.

Each edge (relationship) may contain an arbitrary number of attributes of different types. Ribs with the same label are not required to contain an identical set of attributes.

The prefractal graph database consists of two interconnected blocks: data block and metadata block. The data block contains nodes with attributes and nested subgraphs, as well as all edges with attributes. In other words, the data block carries the data itself that makes up the database. The metadata block contains the metadata model:
Categories of nodes (node labels).
Categories of edges (labels of edges).
Relationships of categories (inheritance).

Category attributes are a list of attributes of different types, mandatory for nodes and edges labeled with corresponding labels. Every node and edge labeled with the corresponding labels contains such attributes. However, this does not prevent a user from storing an arbitrary number of additional attributes in nodes and edges.

Data type descriptions contains a library of data types described in addition to the base set. Data types can be both primitives, e.g. numbers, strings, date and time, and structures, e.g. lists, dictionaries, sets and others. Descriptions of categories with all attributes are also data types. Templates of graph structures can also be data types. Functions are a special data type. Attributes corresponding to this type are pointers to functions described in the metadata block and ready to be executed in the space of the corresponding node or edge.

Generalized data model contains a graph consisting of nodes symbolizing a set of similar nodes from a data block connected by similar edges. The generalized model is secondary to the data. In other words, it is impossible to change the generalized model without changing the data itself. Although, it is possible to change the list of category attributes. On the other hand, forming nodes and links of a new type or deleting all nodes or links of an old type automatically corrects the generalized data model.

Relational databases can be emulated as a limited subset of a prefractal graph database. In this case, nodes are analogous to a record in a relational table. Such nodes can have only one label corresponding to the table name. All fields of a relational table are represented in this case by attributes of the category corresponding to this table. The edges describing relations between tables cannot contain attributes and their labels must correspond to the keys forming the relation. Any SQL query generated for a relational database can be unambiguously and reversibly converted for the prefractal graph emulating it. Thus, a database based on prefractal graphs is not inferior in versatility to relational databases, but is guaranteed to surpass them in performance, since graph relations do not require additional calculations during a query, as required by virtual relations of a relational database.

Key-Value databases can be emulated as a limited subset of a prefractal graph database. In this case, nodes are analogous to keys in Key-Value databases, and attributes are analogous to values. Another emulation option could be to implement a dictionary type attribute. This turns a single node attribute into a local Key-Value database. Since dictionaries in a prefractal graph database can be organized in exactly the same way as in a Key-Value database, the performance of the corresponding queries will not be inferior.

Graph databases can be emulated as a limited subset of a prefractal graph database. In this case, nodes are analogous to nodes in a graph database. Such nodes cannot have a hierarchical structure, i.e., they can only be of the first level. The edges of a prefractal graph database are analogous to the edges in a graph database. Any query generated for a graph database can be unambiguously and reversibly converted for the prefractal graph emulating it. Thus, a database based on prefractal graphs is not inferior in performance to graph databases, but provides a number of features unattainable in graph databases, such as metadata model, hierarchies, and structural type attributes.

Document-oriented databases can be emulated as a limited subset of a prefractal graph database. In this case, prefractal graph nodes are analogous to internal and leaf nodes in Document-oriented databases. Such nodes cannot form links with other nodes, but only form hierarchies. Any query generated for Document-oriented databases can be unambiguously and reversibly converted for the prefractal graph emulating it. Thus, a database based on prefractal graphs is not inferior in performance to Document-oriented databases, but provides a number of features unattainable in Document-oriented databases, for example, such as the formation of links between nodes or metadata model.

Time Series databases can be emulated as a limited subset of the prefractal graph database. In this case, an emulation option may be to implement a Time Series type attribute. This turns a single node attribute into a local Time Series databases. Since time series in a prefractal graph database can be organized in exactly the same way as in Time Series databases, the performance of the corresponding queries will not be inferior.

Object databases can be emulated as a limited subset of a prefractal graph database. In this case, nodes are analogous to objects in Object databases. The edges of a prefractal graph database are the analog of associations in Object databases. Functional attributes of a prefractal graph database are analogous to functions in Object databases. Prefractal graph database metadata model—analog of UML model in Object databases. Any query generated for Object databases can be unambiguously and reversibly converted for the prefractal graph emulating it. Thus, the database based on prefractal graphs is not inferior in performance to Object databases, but surpasses it in versatility and plasticity, because, for example, it allows you to form search queries to nodes that have no connection between themselves, or allows you to change the metadata model in the process of database operation, which is impossible in Object databases, because it requires a preliminary reconstruction of the architecture.

The compute engine of the prefractal graph database can be based on matrix descriptions and linear algebra operations. In this way arbitrary graphs are described and graph algorithms are realized. Arbitrary hierarchical structures can be described in the same way.

The implementation of a compute engine of a linear algebra-based prefractal graph database enables computation by multiple parallel threads, which allows the use of GPUs or other multithreaded processors for performance acceleration.

The structure of prefractal graphs combined with arbitrary data types, such as tensors, allows the construction of databases with built-in AI modules, such as neural networks, which allows searching even unindexed data much faster than linearly. It also allows searching over fuzzy and noisy data.

Applying the concept of prefractal graphs to databases allows to create a new generation of universal databases that take the best from other types of databases and achieve the highest performance for any data storage, retrieval and processing tasks. The advantages of this new system are summarized in the table shown in FIG. 5.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

I claim as follows:

1. A database management system that enables users to retrieve and process information contained within a database comprised of data and metadata, said system comprising:
a prefractal graph structure having a plurality of nodes connected by arbitrary directed or undirected edges with each other, each node selectively further comprising a separate graph structure and each node being labeled with one or more labels that define to which category the node belongs, said edges defining a relationship between said nodes, wherein each edge is labeled with one or more labels that define which category the relationship belongs to,
wherein each node and each edge further comprises an attribute of any desired type.

2. The database management system of claim 1, wherein said desired type is a user-defined type.

3. The database management system of claim 1, wherein said desired type is a structural data type, such as dictionaries, sets, tensors, time series and others.

4. The database management system of claim 1, wherein said attributes of said nodes and said edge is a function.

5. The database management system of claim 1, further comprising two interconnected blocks, said blocks being a data block and a metadata block, wherein said data block includes the nodes with attributes and nested subgraphs and all edges with attributes, and wherein said metadata block includes a metadata model comprising node labels, edges labels of edges, and relationships of categories.

6. The database management system of claim 1, wherein all calculations in graphs and in hierarchies of graphs are carried out using linear algebra tools.
